(19) United States
(12) Patent Application Publication
(10) Pub. No.: US 2026/0073713 A1
(43) Pub. Date: Mar. 12, 2026

(54) ELECTRONIC APPARATUS FOR PROVIDING SOUND CORRESPONDING TO CHARACTERISTIC INFORMATION OF OBJECT AND CONTROL METHOD THEREOF

(71) Applicant: SAMSUNG ELECTRONICS CO., LTD., Suwon-si (KR)

(72) Inventors: Donghyun KIM, Suwon-si (KR); Jinhee PYUN, Suwon-si (KR)

(73) Assignee: SAMSUNG ELECTRONICS CO., LTD., Suwon-si (KR)

(21) Appl. No.: 19/330,319

(22) Filed: Sep. 16, 2025

Related U.S. Application Data
(63) Continuation of application No. PCT/KR2025/012122, filed on Aug. 11, 2025.

(30) Foreign Application Priority Data
Sep. 10, 2024 (KR) 10-2024-0123228

(51) Int. Cl. G06V 20/68; G06F 3/16; G06V 10/776; G06V 10/82; G06V 20/52; G06V 40/20

(52) U.S. Cl. CPC G06V 20/68; G06F 3/165; G06V 10/776; G06V 10/82; G06V 20/52; G06V 40/20

(57) ABSTRACT

An electronic apparatus may include: a camera; memory storing instructions and at least one processor including processing circuitry. The instructions, when executed by the at least one processor individually or collectively, may cause the electronic apparatus to: obtain an image comprising an object, using the camera; identify characteristic information about the object; and generate a first sound corresponding to the object based on the characteristic information.

### CROSS-REFERENCE TO RELATED APPLICATIONS

This application is a continuation of PCT/KR2025/012122, filed on Aug. 11, 2025, in the Korean Intellectual Property Receiving Office, which is based on and claims priority to Korean Patent Application No. 10-2024-0123228, filed on Sep. 10, 2024, in the Korean Intellectual Property Office, the disclosures of which are incorporated by reference herein in their entireties.

### BACKGROUND

### 1. Field

The disclosure relates to an electronic apparatus and a control method thereof, and more particularly, to an electronic apparatus for providing a sound corresponding to characteristic information of an object and a control method thereof.

### 2. Description of Relate Art

With the development of electronic technology, various types of electronic apparatuses are being developed. In particular, apparatuses such as a wine cellar for storing wine have been popularized recently, thereby improving user convenience.

A user may capture wine using a smartphone to recognize a label, and then acquire wine information or identify its position in the wine cellar.

However, in the related art, the smartphone or the wine cellar recommended wines by considering the taste of the wine or did not recommend wines that match the current situation.

That is, although the user wants to select the wine that is most appropriate for the current situation, it may be difficult to identify all the characteristics of numerous wines stored in the wine cellar or to look the characteristics of the wine up every time.

### SUMMARY

According to an aspect of the disclosure, an electronic apparatus may include: a camera; memory storing instructions; and at least one processor including processing circuitry. The instructions, when executed by the at least one processor individually or collectively, may cause the electronic apparatus to: obtain an image comprising an object, using the camera; identify characteristic information about the object; generate a first sound corresponding to the object based on the characteristic information.

The memory may be further configured to store a first neural network model trained to output data comprising vector data representing a sound based on inputting input data, and the instructions, when executed by the at least one processor individually or collectively, may further cause the electronic apparatus to: obtain a first data comprising a first vector by inputting at least one of the characteristic information or the image to the first neural network model; and generate the first sound based on the first data.

The memory may be further configured to store a plurality of second vectors acquired by encoding a plurality of sound sources, and the instructions, when executed by the at least one processor individually or collectively, may further cause the electronic apparatus to: identify a second vector having a highest similarity to the first vector among the plurality of second vectors; and generate the first sound based on the second vector.

To generate the first sound may be to generate the first data.

The memory may be further configured to store a second neural network model trained to output data comprising a vector data representing a voice based on inputting input data, and a third neural network model trained to output sound comprising a sound in voice based on inputting the data, and the instructions, when executed by the at least one processor individually or collectively, may further cause the electronic apparatus to: obtain a second data based on inputting at least one of the characteristic information or the image to the second neural network model; and generate the first sound as a form of the sound in voice based on inputting the second data to the third neural network model.

The electronic apparatus may further include: at least one rack; and a speaker. The instructions, when executed by the at least one processor individually or collectively, may further cause the electronic apparatus to: obtain the image by capturing one rack among the at least one rack by the camera based on a position of the one rack being changed; and output the first sound through the speaker.

The instructions, when executed by the at least one processor individually or collectively, may further cause the electronic apparatus to identify the object among a plurality of objects comprised in the image, based on that a user points the object.

The electronic apparatus may further include: a communication interface. The instructions, when executed by the at least one processor individually or collectively, may further cause the electronic apparatus to: receive the characteristic information through the communication interface.

The object may be wine, and the instructions, when executed by the at least one processor individually or collectively, may further cause the electronic apparatus to: identify the characteristic information comprising at least one of: winery information, type, grape variety, grape production region, style, alcohol concentration, sweetness, acidity, tannin, or body of the wine, based on a label in the image.

The electronic apparatus as claimed in claim 1, may further include: a microphone; and a speaker. The instructions, when executed by the at least one processor individually or collectively, may further cause the electronic apparatus to: identify the object among a plurality of objects inside the electronic apparatus based on a second sound received through the microphone; and output the first sound corresponding to the object through the speaker.

The electronic apparatus may further include: at least one rack. The instructions, when executed by the at least one processor individually or collectively, may further cause the electronic apparatus to change a position of a rack holding the object is placed among the at least one rack.

The electronic apparatus may further include: a communication interface. The instructions, when executed by the at least one processor individually or collectively, may further cause the electronic apparatus to: identify the object among a plurality of objects inside the electronic apparatus based on a second sound received from a user terminal apparatus through the communication interface.

According to an aspect of the disclosure, a control method of an electronic apparatus, may include, using at least one processor: obtaining an image comprising an object, using a camera; identifying characteristic information about the object; generating a first sound corresponding to the object based on the characteristic information.

The obtaining of the first sound may comprises: obtaining a first data comprising a first vector by inputting at least one of the characteristic information or the image to the first neural network model; and generating the first sound based on the first data. The first neural network model may be trained to output data comprising vector data representing a sound based on inputting input data.

The control method may further include: identifying a second vector having a highest similarity to the first vector among a plurality of second vectors acquired by encoding a plurality of sound sources; and generating the first sound based on the second vector.

The control method may further include: generating the first sound by decoding the first data.

The control method may further comprises: obtaining a second data based on inputting at least one of the characteristic information or the image to a second neural network model trained to output data comprising a vector data representing a voice type based on inputting input data; and generating the first sound as a form of the sound in voice based on inputting the second data to a third neural network model trained to output sound comprising a sound in voice based on inputting the data.

The control method may further include: obtaining the image by capturing one rack among at least one rack of the electronic apparatus, by the camera, based on a position of the one rack being changed; and outputting the first sound through a speaker of the electronic apparatus.

The control method may further include: identifying the object among a plurality of objects comprised in the image based on that a user points the object.

The control method may further include: receiving the characteristic information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic system according to one or more embodiments of the present disclosure;

FIG. 2 is a block diagram illustrating a configuration of an electronic apparatus according to one or more embodiments of the present disclosure;

FIG. 3 is a block diagram illustrating a detailed configuration of the electronic apparatus according to one or more embodiments of the present disclosure;

FIG. 4 is a diagram for describing an object according to one or more embodiments of the present disclosure;

FIG. 5 is a diagram for describing a structure of the electronic apparatus according to one or more embodiments of the present disclosure;

FIG. 6 is a diagram for describing a screen for an inventory status according to one or more embodiments of the present disclosure;

FIG. 7 is a diagram for describing an operation when a user selects an object according to one or more embodiments of the present disclosure;

FIG. 8 is a diagram for describing an operation when the object is selected through a user terminal apparatus according to one or more embodiments of the present disclosure;

FIG. 9 is a diagram for describing characteristic information of the object according to one or more embodiments of the present disclosure;

FIG. 10 is a diagram for describing a method of generating a first sound according to one or more embodiments of the present disclosure;

FIG. 11 is a diagram for describing a method of generating a first sound as a voice according to one or more embodiments of the present disclosure;

FIG. 12 is a diagram for describing an operation when a second sound is received according to one or more embodiments of the present disclosure;

FIG. 13 is a diagram for describing an operation when a second sound is received according to one or more embodiments of the present disclosure;

FIG. 14 is a diagram for describing a learning method and a utilization method of a generative neural network model according to one or more embodiments of the present disclosure;

FIG. 15 is a diagram for describing a learning method and a utilization method of a generative neural network model according to one or more embodiments of the present disclosure; and

FIG. 16 is a flowchart for describing a method of controlling an electronic apparatus according to one or more embodiments of the present disclosure.

### DETAILED DESCRIPTION

The example embodiments of the present disclosure may be diversely modified. Accordingly, specific example embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

An object of the present disclosure provides an electronic apparatus for providing sound corresponding to characteristic information of an object, and a control method thereof.

Hereinafter, embodiments of the disclosure will be described in detail with reference to the accompanying drawings.

General terms that are currently widely used were selected as terms used in embodiments of the disclosure in consideration of functions in the disclosure, but may be changed according to the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in embodiments of the disclosure are to be defined on the basis of the meaning of the terms and the contents throughout the disclosure rather than simple names of the terms.

In the specification, an expression “have”, “may have”, “include”, “may include”, or the like, indicates existence of a corresponding feature (e.g., a numerical value, a function, an operation, a component such as a part, or the like), and does not exclude existence of an additional feature.

An expression “at least one of A or B” is to be understood to mean “A” or “B” or “A and B”.

Expressions “first,” “second,” “1st” or “2nd” or the like, used in the present disclosure may indicate various components regardless of a sequence and/or importance of the components, will be used only in order to distinguish one component from the other components, and do not limit the corresponding components.

Singular forms include plural forms unless the context clearly indicates otherwise. It should be understood that terms “include” or “formed of” used in the specification specify the presence of features, numerals, steps, operations, components, parts, or combinations thereof mentioned in the specification, but do not preclude the presence or addition of one or more other features, numerals, steps, operations, components, parts, or combinations thereof.

In the disclosure, the term user may refer to a person using an electronic apparatus or an apparatus (for example, an artificial intelligence electronic apparatus) using the electronic apparatus.

Hereinafter, diverse embodiments of the disclosure will be described in more detail with reference to the accompanying drawings.

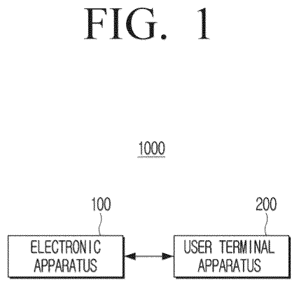

FIG. 1 is a block diagram illustrating a configuration of an electronic system 1000 according to one or more embodiments of the present disclosure. As illustrated in FIG. 1, the electronic system 1000 includes an electronic apparatus 100 and a user terminal apparatus 200.

The electronic apparatus 100 is an apparatus that outputs a sound and may be implemented as a storage apparatus such as a wine cellar or a refrigerator. However, the present disclosure is not limited thereto, and the electronic apparatus 100 may be an apparatus that generates sound and transmits the generated sound to a speaker, a sound bar, a TV, a projector, a desktop PC, a laptop, a smartphone, a tablet PC, smart glasses, a smart watch, etc. However, the present disclosure is not limited thereto, and any electronic apparatus that may output sound or transmit the generated sound to another electronic apparatus may be used the electronic apparatus 100.

The electronic apparatus 100 may identify an object from an image and acquire sound corresponding to the object based on characteristic information about the object. For example, the electronic apparatus 100 may identify wine included in the image and acquire sound corresponding to the wine based on at least one of winery information, type, grape variety, grape production region, style, alcohol concentration, sweetness, acidity, tannin, or body of the wine. However, the present disclosure is not limited thereto, and the electronic apparatus 100 may acquire sound based on any other object.

The electronic apparatus 100 may receive information about an object from the user terminal apparatus 200 and acquire sound corresponding to the object based on characteristic information corresponding to the object. In this case, the electronic apparatus 100 may also transmit the acquired sound to the user terminal apparatus 200.

Alternatively, the electronic apparatus 100 may receive sound from the user terminal apparatus 200 and identify a recommended object among a plurality of objects arranged inside the electronic apparatus 100 based on the sound. In this case, the electronic apparatus 100 may transmit the information about the recommended object to the user terminal apparatus 200.

The user terminal apparatus 200 may be an apparatus that transmits information about an object or sound to the electronic apparatus 100 and receives information about a corresponding object from the electronic apparatus 100. For example, the user terminal apparatus 200 may be implemented as a smartphone, a tablet PC, smart glasses, a smart watch, a speaker, a sound bar, a TV, a projector, a desktop PC, a laptop, etc. However, the present disclosure is not limited thereto, and any apparatus that may communicate with the electronic apparatus 100 may be used as the user terminal apparatus 200.

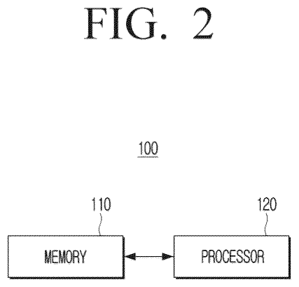

FIG. 2 is a block diagram illustrating the configuration of the electronic apparatus 100 according to one or more embodiments of the present disclosure.

Referring to FIG. 2, the electronic apparatus 100 includes a memory 110 and a processor 120.

The memory 110 may refer to hardware storing information such as data in an electric or magnetic form so that the processor 120, etc., may access the memory 110. To this end, the memory 110 may be implemented as at least one hardware of a non-volatile memory, a volatile memory, a flash memory, a hard disk drive (HDD), a solid state drive (SDD), a RAM, a ROM, or the like.

At least one instruction required for an operation of the electronic apparatus 100 or the processor 120 may be stored in the memory 110. Here, the instruction is a code unit for instructing the operation of the electronic apparatus 100 or the processor 120, and may be written in a machine language, which is a language that a computer may understand. Alternatively, a plurality of instructions that perform a specific task of the electronic apparatus 100 or the processor 120 may be stored in the memory 110 as an instruction set.

The memory 110 may store data that is information in units of bits or bytes capable of representing characters, numbers, images, and the like. For example, a neural network model, sound source information, etc., may be stored in the memory 110.

Here, the neural network model may include at least one of a first neural network model trained to output sound corresponding to first input data as data in a vector form (vector data), a second neural network model trained to output a voice type corresponding to second input data as the data in the vector form and output setting information describing the second input data, or a third neural network model trained to output sound of voice and contents corresponding to third input data. In addition, the sound source information may include a plurality of second vectors acquired by encoding a plurality of sound sources.

The memory 110 is accessed by the processor 120, and the instruction, the instruction set, or data may be read/written/modified/deleted/updated or the like by the processor 120.

The processor 120 generally controls the operation of the electronic apparatus 100. Specifically, the processor 120 may be connected to each component of the electronic apparatus 100 to generally control an operation of the electronic apparatus 100. For example, the processor 120 may be connected to a component such as the memory 110 to control the operation of the electronic apparatus 100.

One or more processors 120 may include one or more of a central processing unit (CPU), a graphics processing unit (GPU), an accelerated processing unit (APU), a many integrated core (MIC), a neural processing unit (NPU), a hardware accelerator, or a machine learning accelerator. One or more processors 120 may control one or any combination of other components of the electronic apparatus 100 and perform operations related to communication or data processing. One or more processors 120 may execute one or more programs or instructions stored in the memory 110. For example, one or more processors 120 may perform the method according to one or more embodiments of the present disclosure by executing one or more instructions stored in the memory 110.

When the method according to one or more embodiments of the present disclosure includes a plurality of operations, the plurality of operations may be performed by one processor or by a plurality of processors. For example, when a first operation, a second operation, and a third operation are performed by the method according to one or more embodiments, the first operation, the second operation, and the third operation may all be performed by a first processor, the first operation and the second operation may be performed by the first processor (e.g., a general-purpose processor), and the third operation may be performed by a second processor (e.g., an artificial intelligence-specific processor).

One or more processors 120 may be implemented as a single core processor including one core, or one or more multicore processors including a plurality of cores (e.g., homogeneous multicore or heterogeneous multicore). When one or more processors 120 are implemented as a multicore processor, each of the plurality of cores included in the multicore processor may include an internal memory of the processor such as a cache memory and an on-chip memory, and a common cache shared by a plurality of cores may be included in a multicore processor. In addition, each of the plurality of cores (or some of the plurality of cores) included in the multi-core processor may read and perform program instructions for implementing the method according to one or more embodiments of the present disclosure, and all (or part) of the plurality of cores may be linked to read and perform program instructions for implementing the method according to one or more embodiments of the present disclosure.

When the method according to one or more embodiments of the present disclosure includes a plurality of operations, the plurality of operations may be performed by one of a plurality of cores included in a multicore processor, or may be performed by the plurality of cores. For example, when the first operation, the second operation, and the third operation are performed by the method according to one or more embodiments, the first operation, the second operation, and the third operation may all be performed by the first processor in the multicore processor, the first operation and the second operation may be performed by a first core included in the multicore processor, and the third operation may be performed by a second core included in the multicore processor.

In the embodiments of the present disclosure, the processor 120 may be a system-on-chip (SoC) in which one or more processors and other electronic components are integrated, a single-core processor, a multi-core processor, or a core included in the single-core processor or the multi-core processor. Here, the core may be implemented as CPU, GPU, APU, MIC, NPU, a hardware accelerator, a machine learning accelerator, or the like, but embodiments of the present disclosure are not limited thereto. However, for the convenience of description, the operation of the electronic apparatus 100 will be described below using the expression processor 120.

The processor 120 may acquire an image including an object. For example, the processor 120 may acquire an image through a camera included in the electronic apparatus 100. Alternatively, the processor 120 may receive an image from another electronic apparatus, such as the user terminal apparatus 200.

Here, the image may include an object. For example, the image may be an image including at least one wine as an object. However, the present disclosure is not limited thereto, and the image may be an image including ingredients, etc., as an object, and any image may be used as long as it includes an object.

The processor 120 may acquire the characteristic information about the object. For example, the object is wine, and the processor 120 may acquire at least one of the winery information, type, grape variety, grape production region, style, alcohol concentration, sweetness, acidity, tannin, or body of the wine as characteristic information based on a label included in the image.

The memory 110 may store characteristic information for each object. In this case, the processor 120 may identify the object and read out the characteristic information corresponding to the object based on the information stored in the memory 110. Alternatively, the processor 120 may identify an object, transmit information about the identified object to a server, and receive the characteristic information about the object from the server. In this case, the server may store characteristic information for each object.

The processor 120 may acquire a first sound corresponding to the object based on the characteristic information. For example, the processor 120 may input at least one of the characteristic information or the image to the first neural network model to acquire a first vector, and acquire the first sound based on the first vector. Here, the first neural network model may be a neural network model trained to output the sound corresponding to the first input data as data in the form of the vector.

The processor 120 may decode the first vector to generate the first sound. That is, the processor 120 may directly generate the first sound corresponding to the object using the first neural network model.

Alternatively, the memory 110 may further store the plurality of second vectors acquired by encoding the plurality of sound sources, and the processor 120 may identify the second vector having the highest similarity to the first vector among the plurality of second vectors and decode the identified second vector to acquire the first sound. In this case, the processor 120 may use the sound source that most corresponds to the object among the existing sound sources as the first sound. For example, the similarity may be identified in the following manner.

$$similarity ( A , B ) = cos ( θ ) = ( A B ) / ( // A // B // )$$

Alternatively, the processor 120 may input at least one of the characteristic information or the image to the second neural network model to acquire a vector representing the voice type corresponding to the object and descriptive information describing the object, and may input the vector and the descriptive information to the third neural network model to generate the first sound. Here, the second neural network model may be a neural network model trained to output the voice type corresponding to the second input data as the data in the vector form and output the descriptive information describing the second input data, and the third neural network model may be a neural network model trained to output the sound of the voice and contents corresponding to the third input data. In this case, the processor 120 may acquire the first sound describing the object.

The processor 120 may determine at least one of a timbre, a pitch, or a volume of the first sound based on the characteristic information. That is, as in the embodiments described above, the first sound generated directly, the first sound generated from the sound source, and the first sound describing the object may all have similarities in at least one of the timbre, pitch, or volume.

The electronic apparatus 100 further includes at least one rack, a camera, and a speaker, and the processor 120 may acquire an image by capturing at least one of the racks by the camera when the position of the one rack is changed, and output the first sound through the speaker when the first sound is acquired. For example, the processor 120 may capture the image of the rack by the camera when the rack protrudes outward from the internal space of the electronic apparatus 100, and may acquire the first sound based on the characteristic information of the object included in the image, and output the first sound through the speaker. Alternatively, the processor 120 may acquire an image by capturing one rack through the camera when the position of at least one rack is changed and the user's hand is identified on the top of one rack, and identify an object among a plurality of objects based on the user's hand when the plurality of objects are identified in the image, acquire the first sound based on the characteristic information about the object, and output the first sound through the speaker. That is, the processor 120 may acquire an image through the camera when the rack protrudes or the user's hand is identified.

However, the present disclosure is not limited thereto, and the processor 120 may acquire an image when the rack protrudes and identify an object pointed by the user's hand in the image. In this case, the processor 120 may perform re-capturing until the user's hand is identified when the user's hand is not identified in the image.

The camera may be turned off. Thereafter, the processor 120 may turn on the camera when the door included in the electronic apparatus 100 is opened, and perform capturing when the rack protrudes or the user's hand is identified. Thereafter, the processor 120 may turn off the camera when the door is closed.

Alternatively, the processor 120 may continuously perform capturing through the camera after the door is opened to acquire multiple images, and identify the object based on the user's hand among the multiple images. In this case, when the object pointed by the user's hand is changed, the first sound output through the speaker may also be changed. For example, the processor 120 may continuously acquire multiple images through the camera, output the first sound corresponding to the characteristic information about the first object through the speaker when the user's hand points to the first object, and then output the first sound corresponding to the characteristic information about the second object through the speaker when the user's hand is changed from the first object to the second object.

The electronic apparatus 100 further includes a communication interface, and the processor 120 may control the communication interface to acquire the characteristic information about the object, acquire the first sound based on the characteristic information, and transmit the first sound to the user terminal apparatus 200 when the information about the object is received from the user terminal apparatus 200 through the communication interface.

However, the present disclosure is not limited thereto, and the processor 120 may acquire the characteristic information about the object, acquire the first sound based on the characteristic information, and output the first sound through the speaker included in the electronic apparatus 100 when the information about the object is received from the user terminal apparatus 200. In addition, the processor 120 may control the communication interface to transmit the characteristic information about the object to the user terminal apparatus 200.

The electronic apparatus 100 further includes a microphone and a speaker, and when the second sound is received through the microphone, the processor 120 may identify a recommended object among a plurality of objects arranged inside the electronic apparatus 100 based on the second sound, and output a third sound corresponding to the recommended object through the speaker.

For example, when the second sound is received through the microphone, the processor 120 may identify the recommended object among the plurality of objects arranged inside the electronic apparatus 100 based on the second sound, and output the third sound guiding and recommending the position of the recommended object through the speaker. In addition, the electronic apparatus 100 further includes at least one rack, and the processor 120 may change the position of the rack on which the recommended object is arranged among at least one rack. For example, the processor 120 may protrude a rack, on which the recommended object identified based on the second sound, is arranged, outward from the internal space of the electronic apparatus 100.

The electronic apparatus 100 further includes the communication interface, and the processor 120 may control the communication interface to identify the recommended object among the plurality of objects arranged inside the electronic apparatus 100 based on the second sound when the second sound is received from the user terminal apparatus 200 through the communication interface, and transmit the information about the recommended object to the user terminal apparatus 200.

Meanwhile, the function related to the artificial intelligence according to the present disclosure may be operated through the processor 120 and the memory 110.

The processor 120 may be composed of one or more processors. In this case, one or more processors may be general-purpose processors such as a CPU, an AP, and a DSP, graphics-dedicated processors such as a GPU and a VPU, or artificial intelligence-dedicated processors such as an NPU.

One or more processors perform control to process input data according to a predefined operation rule or artificial intelligence model stored in the memory 110. Alternatively, when one or more processors are the artificial intelligence-dedicated processors, the artificial intelligence-dedicated processors may be designed in a hardware structure specialized for processing a specific artificial intelligence model. The predefined operation rule or artificial intelligence model is created through training.

Here, the creation through the training means that a predefined operation rule or artificial intelligence model set to perform a desired characteristic (or purpose) is created by training a basic artificial intelligence model using a plurality of training data by a training algorithm. Such training may be performed in an apparatus itself on which the artificial intelligence according to the disclosure is performed or may be performed through a separate server and/or system. Examples of the training algorithm include supervised training, unsupervised training, semi-supervised training, or reinforcement training, but are not limited thereto.

The AI model may include a plurality of neural network layers. Each of the plurality of neural network layers has a plurality of weight values, and performs a neural network operation through an operation between an operation result of the previous layer and the plurality of weights. The plurality of weights of the plurality of neural network layers may be optimized by a training result of the artificial intelligence model. For example, the plurality of weights may be updated so that a loss value or a cost value obtained from the artificial intelligence model during a training process is decreased or minimized.

The AI neural network may include a deep neural network (DNN), and examples of the AI neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), a deep Q-Network, and the like, but is not limited to the above examples.

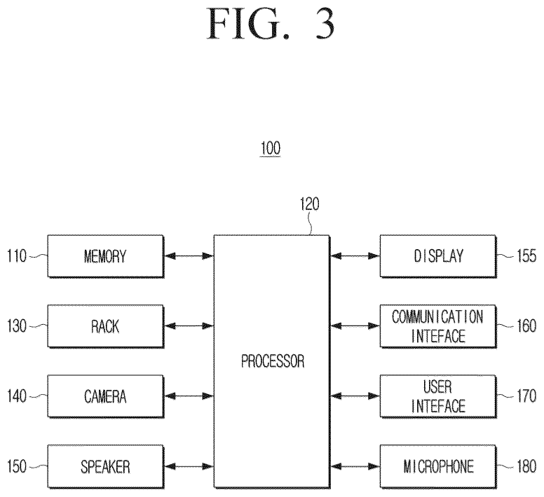

FIG. 3 is a block diagram illustrating the detailed configuration of the electronic apparatus 100 according to one or more embodiments of the present disclosure. The electronic apparatus 100 may include the memory 110 and the processor 120. In addition, referring to FIG. 3, the electronic apparatus 100 may further include a rack 130, a camera 140, a speaker 150, a display 155, a communication interface 160, a user interface 170, and a microphone 180. A detailed description of the components illustrated in FIG. 3 that overlap with the components illustrated in FIG. 2 will be omitted.

The rack 130 is arranged in the internal space of the electronic apparatus 100 and may be protruded outward from the internal space of the electronic apparatus 100 by a user. Alternatively, the rack 130 may include a driving unit, and the processor 120 may control the driving unit to protrude the rack 130 outward from the internal space of the electronic apparatus 100.

The rack 130 may be implemented in a form for storing objects. For example, the rack 130 may be implemented in a ladder form for storing wine. However, it is not limited thereto, and the rack 130 may be in any form as long as it may store objects.

The camera 140 is a component for capturing a still image or a moving image. The camera 140 may capture a still image at a specific point in time, but may also continuously capture a still image.

The camera 140 may capture the front of the electronic apparatus 100 to capture the actual environment in front of the electronic apparatus 100. The processor 120 may also identify an area of interest from an image captured by the camera 140.

The camera 140 may include a lens, a shutter, an aperture, a solid state imaging device, an analog front end (AFE), and a timing generator (TG). The shutter controls the time for light reflected from the subject to enter the camera 140, and the aperture mechanically increases or decreases the size of the opening through which light enters to control the amount of light incident on the lens. When the solid state imaging device accumulates the light reflected from the subject as photocharges, it outputs an image by the photocharges as an electrical signal. The TG outputs a timing signal for reading out pixel data of the solid state imaging device, and the AFE samples and digitizes the electrical signal output from the solid state imaging device.

The speaker 150 is a component outputting various notification sounds, an audio message, or the like, as well as various audio data processed by the processor 120.

The display 155 is a configuration that displays an image, and may be implemented as various types of displays such as a liquid crystal display (LCD), an organic light emitting diode (OLED) display, a plasma display panel (PDP), and the like. A driving circuit, a backlight unit, and the like, that may be implemented in the form such as an a-si thin film transistor (TFT), a low temperature poly silicon (LTPS), a TFT, an organic TFT (OTFT), and the like, may be included in the display 155. Meanwhile, the display 155 may be implemented as a touch screen combined with a touch sensor, a flexible display, a three-dimensional (3D) display, or the like.

The communication interface 160 is a component performing communication with various types of external apparatuses depending on various types of communication manners. For example, the electronic apparatus 100 may perform communication with the user terminal apparatus or the server through the communication interface 160.

The communication interface 160 may include a wireless fidelity (WiFi) module, a Bluetooth module, an infrared communication module, a wireless communication module, and the like. Here, each communication module may be implemented in the form of at least one hardware chip.

The Wi-Fi module and the Bluetooth module perform communication in a Wi-Fi manner and a Bluetooth manner, respectively. When the Wi-Fi module or the Bluetooth module is used, various connection information such as a service set identifier (SSID), a session key, and the like, is first transmitted and received, communication is connected using the connection information, and various information may then be transmitted and received. The infrared communication module performs communication according to an infrared data association (IrDA) technology of wirelessly transmitting data to a short distance using an infrared ray positioned between a visible ray and a millimeter wave.

The wireless communication module may include at least one communication chip performing communication according to various wireless communication standards such as zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

Alternatively, the communication interface 160 may include a wired communication interface such as HDMI, DP, Thunderbolt, USB, RGB, D-SUB, and DVI.

In addition, the communication interface 160 may include a local area network (LAN) module, an Ethernet module, and at least one of wired communication modules performing communication using a pair cable, a coaxial cable, an optical fiber cable, etc.

The user interface 170 may be implemented as a button, a touch pad, a mouse, a keyboard, etc., or may be implemented as a touch screen that may perform both of the display function and manipulation input function. Here, the button may be various types of buttons such as a mechanical button, a touch pad, a wheel, and the like, formed in any region such as a front surface portion, a side surface portion, a back surface portion, and the like, of a body appearance of the electronic apparatus 100.

The microphone 180 is configured to receive sound and convert the sound into an audio signal. The microphone 180 is electrically connected to the processor 120 and may receive sound under the control of the processor 120.

For example, the microphone 180 may be formed integrally with an upper side, a front surface, a side surface, or the like, of the electronic apparatus 100. Alternatively, the microphone 180 may be installed on a remote control separate from the electronic apparatus 100. In this case, the remote control may receive sound through the microphone 180 and provide the received sound to the electronic apparatus 100.

The microphone 180 may include various components such as a microphone collecting sound having an analog form, an amplifying circuit amplifying the collected sound, an A/D converting circuit sampling the amplified sound to convert the amplified user voice into a digital signal, a filter circuit removing a noise component from the converted digital signal, and the like.

Meanwhile, the microphone 180 may be implemented in the form of a sound sensor, and any configuration that may collect sound can be used.

As described above, the electronic apparatus 100 may identify an object included in an image and provide sound based on the characteristic information about the object, thereby improving user convenience.

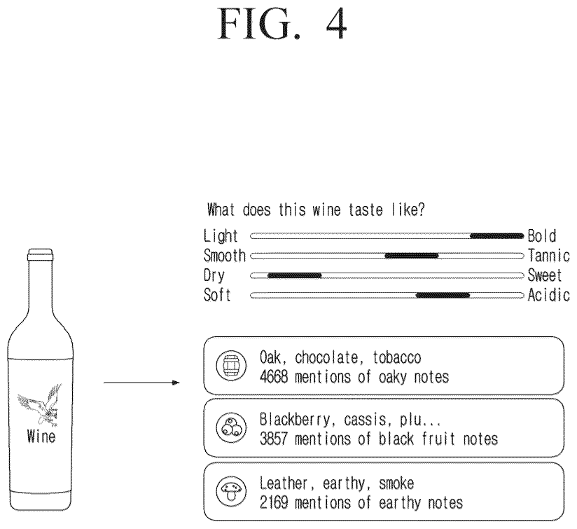

Hereinafter, the operation of the electronic apparatus 100 will be described in more detail with reference to FIGS. 4 to 15. In FIGS. 4 to 15, individual embodiments are described for convenience of description. However, individual embodiments of FIGS. 4 to 15 may be implemented in any combination.

FIG. 4 is a diagram for describing an object according to one or more embodiments of the present disclosure.

The processor 120 may identify an object included in an image. For example, the processor 120 may identify wine in an image, as illustrated in FIG. 4, and acquire information about taste (light, smooth, dry, soft, etc.) of the wine, user comments, etc. Alternatively, the processor 120 may acquire at least one of the winery information, type, grape variety, grape production region, style, alcohol concentration, sugar content, acidity, tannin, or body of the wine based on the label of the wine.

However, the present disclosure is not limited thereto, and the processor 120 may acquire various types of information about an object without limitation.

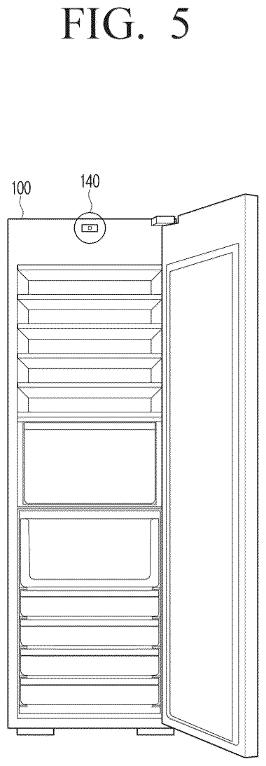

FIG. 5 is a diagram for describing the structure of the electronic apparatus 100 according to one or more embodiments of the present disclosure.

The electronic apparatus 100 may include the plurality of racks 130 for storing objects inside the electronic apparatus 100. The racks 130 may protrude outward from the internal space of the electronic apparatus 100. For example, a user may pull the desired rack 130 to protrude the rack 130 outward from the internal space of the electronic apparatus 100. Alternatively, the user may select one of the plurality of racks 130 through the user terminal apparatus 200, and the user terminal apparatus 200 may transmit the information about the rack 130 selected by the user to the electronic apparatus 100. The processor 120 may protrude the rack 130 corresponding to the information received from the user terminal apparatus 200. In this case, each rack 130 may further include a driving unit.

The electronic apparatus 100 includes the camera 140, and the processor 120 may acquire an image of the protruding rack 130 through the camera 140.

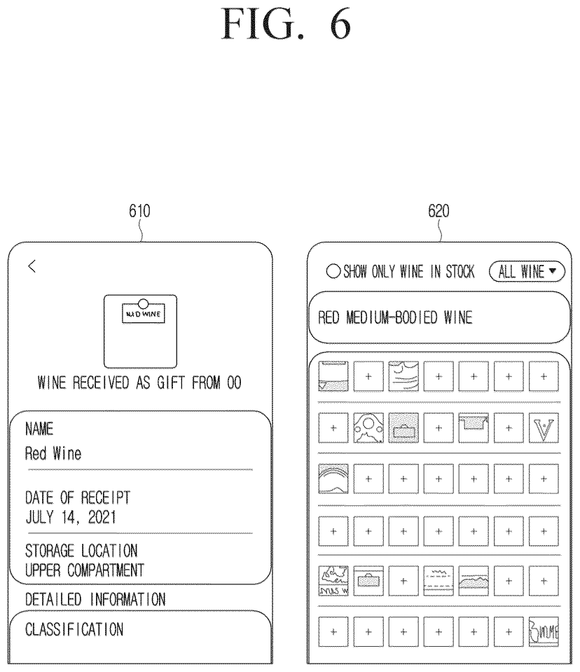

FIG. 6 is a diagram for describing a screen for an inventory status according to one or more embodiments of the present disclosure.

The user may confirm the inventory status of the object stored in the electronic apparatus 100 through the user terminal apparatus 200. For example, the user terminal apparatus 200 may provide a first screen 610 including information about a date of receipt, a storage location, etc., of wine, as illustrated on the left side of FIG. 6. In addition, the user terminal apparatus 200 may provide a second screen 620 indicating the inventory status of the wine stored in the plurality of racks 130 of the electronic apparatus 100, as illustrated on the right side of FIG. 6.

According to one or more embodiments, the user terminal apparatus 200 may provide the first screen 610 indicating information about the selected wine according to a user command to select an icon of a specific wine on the second screen 620.

The processor 120 may perform different operations when an object is received or released and when a stored object is selected. For example, the processor 120 may acquire multiple images through the camera 140, analyze the multiple images, and output the first sound corresponding to the selected object based on the characteristic information about the selected object when the rack 130 protrudes and a specific object is selected from the rack 130 by the user's hand. Alternatively, the processor 120 may acquire the multiple images through the camera 140, analyze the multiple images, and identify that an object is stored in an empty space on the rack 130, acquire information about the stored object, and provide the acquired information and the storage position, etc., to the user terminal apparatus 200. The user terminal apparatus 200 may update the first screen 610 and the second screen 620 based on the received information. For example, the user terminal apparatus 200 may update the second screen 620 based on the image of the object among the received information, and update the first screen 610 based on the information describing the object among the received information. The processor 120 may acquire similar information even when an object is shipped and provide the acquired information to the user terminal apparatus 200.

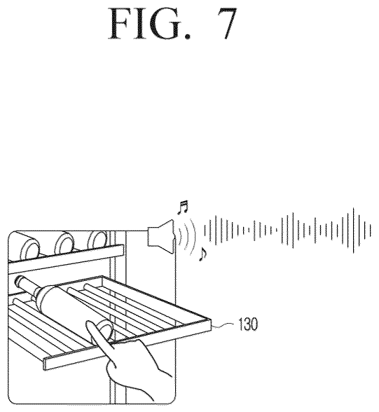

FIG. 7 is a diagram for describing an operation when a user selects an object according to one or more embodiments of the present disclosure.

When a user protrudes the rack 130, the processor 120 may capture the image of the rack 130 through the camera 140, and output the first sound corresponding to the object based on the characteristic information about the object included in the image.

For example, as illustrated in FIG. 7, when a user protrudes the rack 130, the processor 120 may capture the image of the rack 130 through the camera 140, identify an object pointed by the user's hand in the image, acquire the characteristic information about the object, input at least one of the characteristic information or the image to a first neural network model to acquire a first vector, and decode the first vector to output the acquired first sound. For example, when the object is wine, the processor 120 may acquire, as the characteristic information, at least one of the winery information, type, grape variety, grape production region, style, alcohol concentration, sugar content, acidity, tannin, or body of the wine based on the label of the wine.

When the object is not identified from the image, the processor 120 may input the image to the first neural network model to acquire the first vector, and output the first sound acquired by decoding the first vector.

However, the present disclosure is not limited thereto, and the processor 120 may continuously acquire a plurality of images through the camera 140 when a door included in the electronic apparatus 100 is opened.

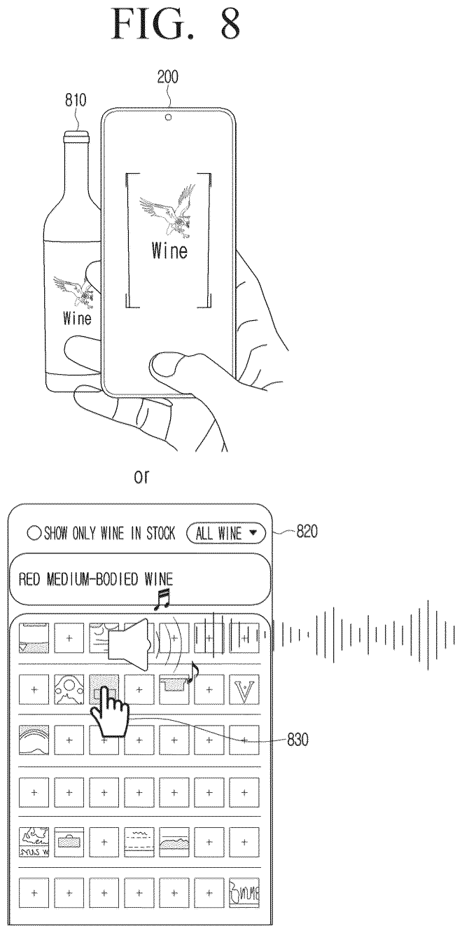

FIG. 8 is a diagram for describing an operation when the object is selected through the user terminal apparatus 200 according to one or more embodiments of the present disclosure.

The user terminal apparatus 200 may output the first sound related to the object according to the user's control. For example, a user may capture wine 810 using the user terminal apparatus 200, as illustrated in the upper part of FIG. 8. In this case, the user terminal apparatus 200 may transmit the captured image including wine 810 to the electronic apparatus 100.

When the captured image is received from the user terminal apparatus 200, the processor 120 may acquire the first sound corresponding to the wine 810 based on characteristic information about wine 810 including the captured image, and transmit the first sound to the user terminal apparatus 200. The user terminal apparatus 200 may output the first sound received from the electronic apparatus 100.

The processor 120 identifies a distance to the user terminal apparatus 200, and when the distance to the user terminal apparatus 200 is greater than or equal to a preset distance, transmits the first sound to the user terminal apparatus 200, and when the distance to the user terminal apparatus 200 is less than or equal to the preset distance, outputs the first sound directly.

Alternatively, as illustrated in the lower part of FIG. 8, the user may select an icon 830 of a specific wine on the second screen 820 displayed by the user terminal apparatus 200. The user terminal apparatus 200 may transmit information about the selected wine to the electronic apparatus 100 according to a user command to select the icon of the specific wine on the second screen 820.

When the processor 120 receives the information about the selected wine from the user terminal apparatus 200, it may acquire the first sound corresponding to the wine based on the characteristic information about the wine, and transmit the first sound to the user terminal apparatus 200. The user terminal apparatus 200 may output the first sound received from the electronic apparatus 100. In addition, the user terminal apparatus 200 may output the first sound and display a first screen illustrating the information about the selected wine.

The processor 120 identifies a distance to the user terminal apparatus 200, and when the distance to the user terminal apparatus 200 is greater than or equal to a preset distance, transmits the first sound to the user terminal apparatus 200, and when the distance to the user terminal apparatus 200 is less than or equal to the preset distance, outputs the first sound directly.

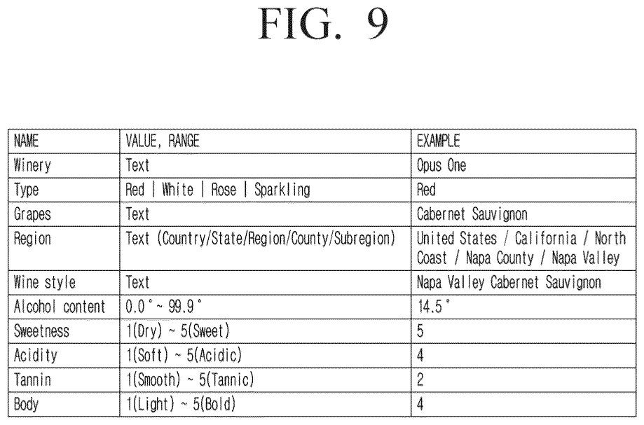

FIG. 9 is a diagram for describing characteristic information about the object according to one or more embodiments of the present disclosure.

The processor 120 may identify an object from an image. When the plurality of objects are identified from the image, the processor 120 may identify one of the plurality of objects based on the user's hand.

When the object is identified, the processor 120 may acquire the characteristic information about the object. For example, when the wine is identified, the processor 120 may acquire, as the characteristic information, at least one of the winery information, type, grape variety, grape production region, style, alcohol concentration, sugar content, acidity, tannin, or body of the wine based on the label of the wine. For example, the characteristic information about the wine may include type and specific information by category, as illustrated in FIG. 9. However, the present disclosure is not limited thereto, and the processor 120 may acquire characteristic information about various objects, and categories included in each characteristic information may also be diverse.

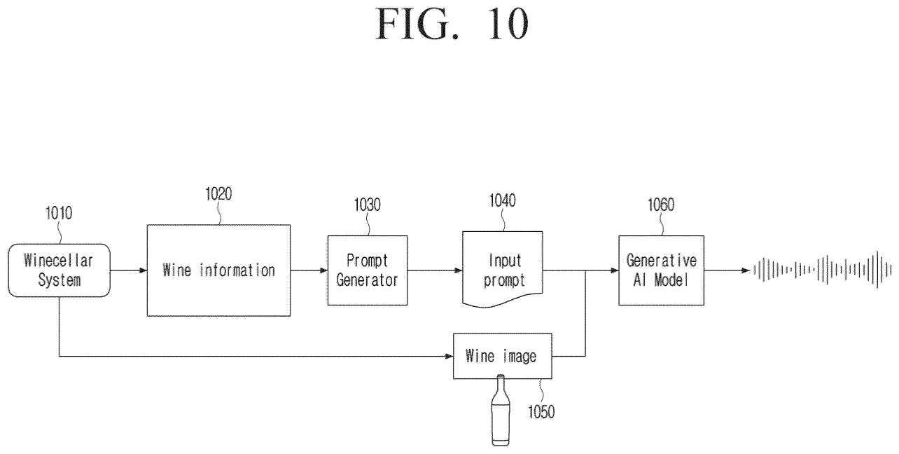

FIG. 10 is a diagram for describing a method of generating a first sound according to one or more embodiments of the present disclosure. In FIG. 10, for convenience of description, it is described that the electronic apparatus 100 is a wine cellar 1010 and the object is wine.

The wine cellar 1010 may identify wine from an image, and acquire information 1020 about wine by identifying the wine.

A prompt generator 1030 may acquire characteristic information about the wine based on the identified wine, and generate an input prompt 1040 based on the characteristic information about the wine. For example, the prompt generator 1030 may generate the following input prompt 1040.

```
prompt = f”““Create a music piece that pairs perfectly with the following
wine:
  Winery: {winery}
  Type: {wine_type}
  Grapes: {grapes}
  Region: {region}
  Wine Style: {wine_style}
  Alcohol Content: {alcohol_content}%
  Sweetness: {sweetness}/5
  Acidity: {Acidity}/5
  Tannin: {tannin}/5
  Body: {Body}/5
```

The music should evoke the characteristics and ambiance of this wine, capturing its essence and the experience of enjoying it.” ““

The first neural network model (generative AI model) 1060 may receive an input prompt 1040 and a wine image 1050 and output the first sound corresponding to the wine.

The above describes a case where the wine is identified, but the wine may not be identified. In this case, the prompt generator 1030 may also generate the following input prompt 1040.

prompt=f” ““Create a music piece that pairs perfectly with the given image.

The music should evoke the characteristics and ambiance of this wine, capturing its essence and the experience of enjoying it.” ““

The first neural network model 1060 may receive the input prompt 1040 and the wine image 1050 and output the first sound corresponding to the wine. In this case, the first neural network model 1060 may output the first sound based on the wine image 1050.

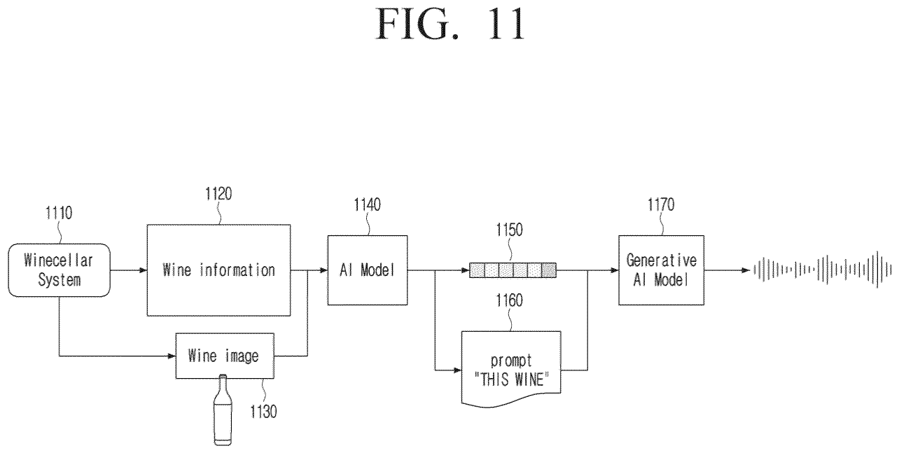

FIG. 11 is a diagram for describing a method of generating a first sound as a voice according to one or more embodiments of the present disclosure. In FIG. 11, for convenience of description, it is described that the electronic apparatus 100 is a wine cellar 1110 and the object is wine.

The wine cellar 1110 may identify wine from an image, and acquire information 1120 about the wine by identifying the wine.

The second neural network model (AI model) 1140 may input information 1120 about the wine and a wine image 1130, and output a vector 1150 representing a voice type corresponding to the wine, and a prompt (descriptive information) 1160 describing the wine.

However, the present disclosure is not limited thereto, and the second neural network model 1140 may input the characteristic information about the wine and a wine image 1130 generated through a prompt generator, and output a vector 1150 representing a voice type corresponding to the wine and a prompt 1160 describing the wine.

A third neural network model (generative AI model) 1170 may input the vector 1150 and the prompt 1160, and output the first sound corresponding to the wine. Here, the first sound may be information that sounds the contents of the prompt 1160 in a voice corresponding to the vector 1150.

The second neural network model 1140 may be a model that trains sample information about wine and a sample wine image as input data, and a sample vector representing a voice type corresponding to wine and a sample prompt describing the wine as output data.

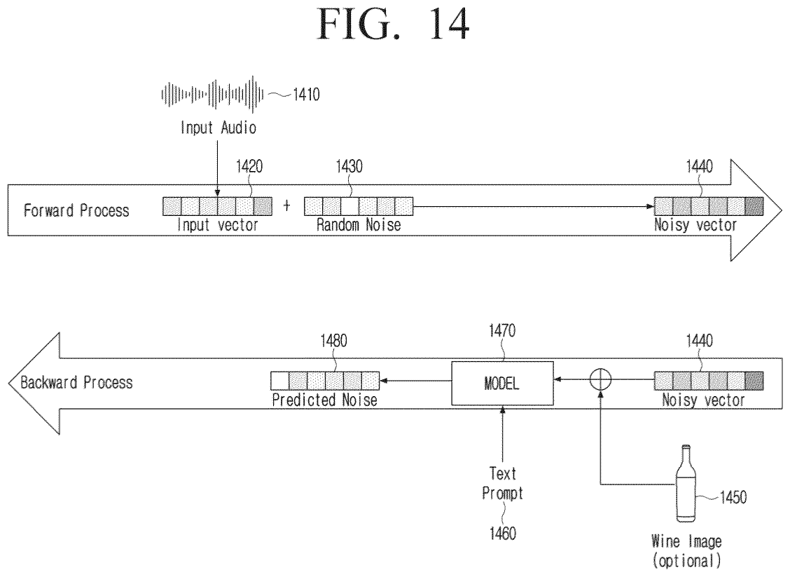

The first neural network model 1060 of FIG. 10 and the third neural network model 1170 of FIG. 11 are generative neural network models, and an example of their learning method is described with reference to FIG. 14.

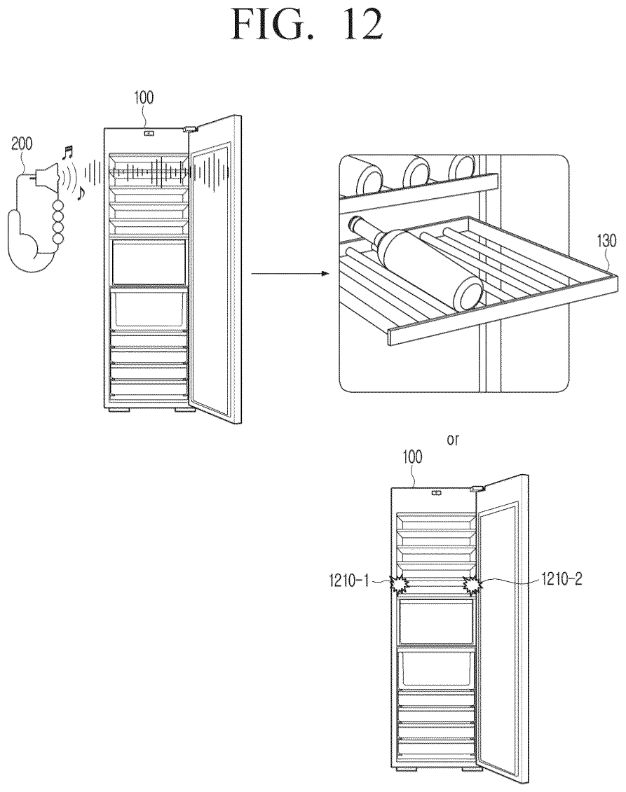

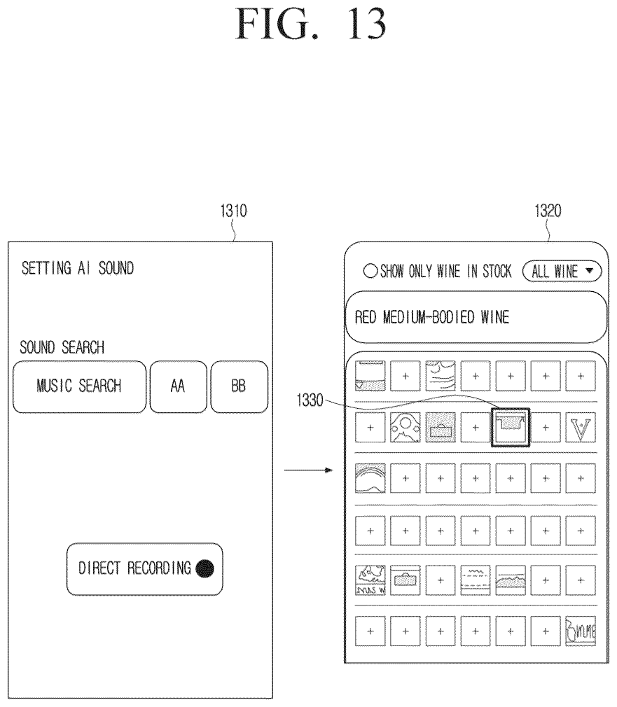

FIGS. 12 and 13 are diagrams for describing an operation when a second sound is received according to one or more embodiments of the present disclosure.

When the second sound is received through the microphone 180, the processor 120 identifies the recommended object among the plurality of objects arranged inside the electronic apparatus 100 based on the second sound, and changes the position of the rack 130 on which the recommended object is arranged.

For example, a user may output the second sound through the user terminal apparatus 200, and the processor 120 may receive the second sound through the microphone 180, as illustrated in the upper left of FIG. 12. The processor 120 may identify a wine that best matches the second sound as the recommended wine, and may protrude the rack 130, on which the recommended wine is arranged, outward from the internal space of the electronic apparatus 100, as illustrated in the upper right of FIG. 12.

Alternatively, the electronic apparatus 100 may further include a plurality of light-emitting elements corresponding to each of the plurality of racks 130, and the processor 120 may turn on light-emitting elements 1210-1 and 1210-2 adjacent to the rack 130 on which the recommended wine is arranged, as illustrated in the lower part of FIG. 12.

When the processor 120 receives the second sound from the user terminal apparatus 200 through the communication interface 160, the processor 120 may identify the recommended object among the plurality of objects arranged inside the electronic apparatus 100 based on the second sound, and control the communication interface 160 to transmit the information about the recommended object to the user terminal apparatus 200.

For example, the user terminal apparatus 200 may provide a screen for recording sound, as illustrated in the left side of FIG. 13, and when the second sound is recorded according to the user's control, the second sound may be transmitted to the electronic apparatus 100. The processor 120 may identify the recommended object among the plurality of objects arranged inside the electronic apparatus 100 based on the second sound, and control the communication interface 160 to transmit the information about the recommended object to the user terminal apparatus 200. The user terminal apparatus 200 may provide a second screen including a focus 1330 indicating the recommended object based on the information about the recommended object, as illustrated on the right side of FIG. 13.

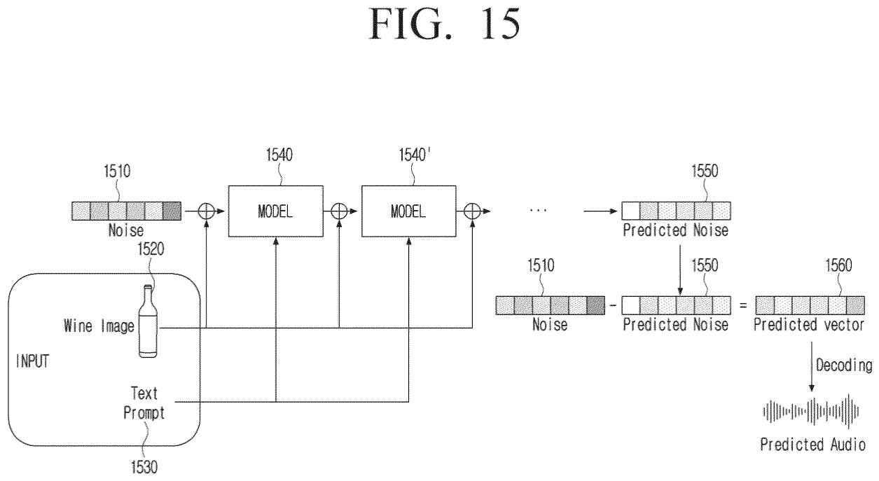

FIGS. 14 and 15 are diagrams for describing a learning method and a utilization method of a generative neural network model according to one or more embodiments of the present disclosure.

First, the processor 120 may train the model 1470, as illustrated in FIG. 14.

For example, the processor 120 may acquire the first vector 1420 that vectorizes the input audio 1410 in the forward process, and acquire the first vector 1440 with added noise by adding a first vector 1420 and a random noise vector 1430.

The processor 120 may acquire a predicted noise 1480 by inputting the first vector 1440 with added noise, a wine image 1450, and a prompt 1460 to the model 1470 in the backward process.

The processor 120 may train the model 1470 so that the difference between the random noise vector 1430 in the forward process and the predicted noise 1480 in the backward process is reduced.

In FIG. 14, for convenience of description, it is described that there is only one model 1470, but it is not limited thereto. For example, the processor 120 may perform training by sequentially using a plurality of models 1470.

When the training is completed, the processor 120 may acquire the first sound by sequentially using the plurality of models 1540, 1540′ for which the training is completed, as illustrated in FIG. 15.

For example, the processor 120 may input noise 1510, a wine image 1520, and a prompt 1530 to the first model 1540, and input the output thereof to the second model 1540′. The processor 120 may repeat this process to acquire predicted noise 1550, and by subtracting the predicted noise 1550 from the noise 1510, a predicted vector 1560 may be acquired. The processor 120 may decode the predicted vector 1560 to acquire the first sound (predicted audio).

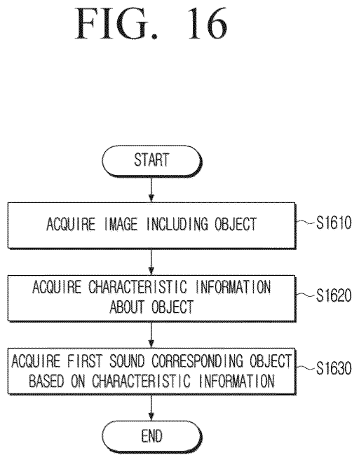

FIG. 16 is a flowchart for describing a method of controlling an electronic apparatus according to one or more embodiments of the present disclosure.

First, an image including an object is acquired (S1610). Then, the characteristic the information about the object is acquired (S1620). Then, the first sound corresponding to the object is acquired based on the characteristic information (S1630).

In addition, the step (S1630) of acquiring the first sound inputs at least one of the characteristic information or the image to the first neural network model to acquire the first vector, and acquires the first sound based on the first vector, and the first neural network model may be a neural network model trained to output the sound corresponding to the first input data as data in the form of the vector.

In addition, the step (S1630) of acquiring the first sound may identify a second vector having the highest similarity to the first vector among a plurality of second vectors acquired by encoding a plurality of sound sources, and decode the identified second vector to acquire the first sound.

In addition, the step (S1630) of acquiring the first sound may decode the first vector to generate the first sound.

The step (S1630) of acquiring the first sound may include inputting at least one of the characteristic information or the image to the second neural network model to acquire the vector representing the voice type corresponding to the object and the descriptive information describing the object and inputting the vector and the descriptive information to the third neural network model to generate the first sound, and the second neural network model may be the neural network model trained to output the voice type corresponding to the second input data as data in the vector form and the descriptive information describing the second input data, and the third neural network model may be the neural network model trained to output the sound of voice and contents corresponding to the third input data.

In addition, the step (S1610) of acquiring the image may further include capturing at least one of the racks included in the electronic apparatus by the camera to acquire the image when the position of the one rack is changed, and outputting the first sound through the speaker included in the electronic apparatus when the first sound is acquired.

The step (S1610) of acquiring the image may include capturing at least one of the racks by the camera to acquire the image when the position of the one rack is changed and the user's hand is identified on the top of the one rack, and identifying the object among the plurality of objects based on the user's hand when the plurality of objects are identified in the image.

In addition, the step (S1620) of acquiring the characteristic information may further include acquiring the characteristic information about the object when the information about the object is received from the user terminal apparatus, and the control method may further include transmitting the first sound to the user terminal apparatus.

For example, the object is wine, and the step (S1620) of acquiring the characteristic information may acquire at least one of the winery information, type, grape variety, grape production region, style, alcohol concentration, sweetness, acidity, tannin, or body of the wine as characteristic information based on a label included in the image.

In addition, when the second sound is received through the microphone included in the electronic apparatus, the control method may further include identifying the recommended object among the plurality of objects arranged inside the electronic apparatus based on the second sound and outputting the third sound corresponding to the recommended object through the speaker included in the electronic apparatus.

The control method may further include changing the position of the rack on which the recommended object is arranged among at least one rack included in the electronic apparatus.

In addition, when the second sound is received from the user terminal apparatus, the control method may further include identifying the recommended object among the plurality of objects arranged inside the electronic apparatus based on the second sound, and transmitting the information about the recommended object to the user terminal apparatus.

The step (S1630) of acquiring the first sound may determine at least one of a timbre, a pitch, or a volume of the first sound based on the characteristic information.

As described above, according to various embodiments of the present disclosure, the electronic apparatus may identify the object included in the image and provide the sound based on the characteristic information about the object, thereby improving the user convenience.

Meanwhile, according to one or more embodiments of the disclosure, the diverse embodiments described above may be implemented as software including instructions stored in a machine-readable storage medium (e.g., a computer-readable storage medium). A machine may be an apparatus that invokes the stored instruction from the storage medium and may be operated according to the invoked instruction, and may include the electronic apparatus (e.g., the electronic apparatus A) according to the disclosed embodiments. When the instruction is executed by a processor, the processor may perform the function corresponding to the instruction directly or by using other components under the control of the processor. The command may include codes created or executed by a compiler or an interpreter. The machine-readable storage medium may be provided in a form of a non-transitory storage medium. Here, the term ‘non-transitory’ means that the storage medium is tangible without including a signal, and does not distinguish whether data are semi-permanently or temporarily stored in the storage medium.

In addition, according to one or more embodiments of the disclosure, the methods according to the diverse embodiments described above may be included and provided in a computer program product. The computer program product may be traded as a product between a seller and a purchaser. The computer program product may be distributed in the form of a storage medium (e.g., a compact disc read only memory (CD-ROM)) that may be read by the machine or online through an application store (e.g., PlayStore™). In a case of the online distribution, at least portions of the computer program product may be at least temporarily stored in a storage medium such as a memory of a manufacturer server, an application store server, or a relay server or be temporarily created.

In addition, according to one or more embodiments of the disclosure, the diverse embodiments described above may be implemented in a computer or a computer-readable recording medium using software, hardware, or a combination of software and hardware. In some cases, embodiments described in the disclosure may be implemented as a processor itself. According to a software implementation, embodiments such as procedures and functions described in the specification may be implemented as separate software. Each software may perform one or more functions and operations described in the disclosure.

Meanwhile, computer instructions for performing processing operations of the machines according to the diverse embodiment of the disclosure described above may be stored in a non-transitory computer-readable medium. The computer instructions stored in the non-transitory computer-readable medium allow a specific machine to perform the processing operations in the machine according to the diverse embodiments described above when they are executed by a processor of the specific machine. The non-transitory computer-readable medium is not a medium that stores data for a while, such as a register, a cache, a memory, or the like, but means a medium that semi-permanently stores data and is readable by the apparatus. Specific examples of the non-transitory computer-readable medium may include a compact disk (CD), a digital versatile disk (DVD), a hard disk, a Blu-ray disk, a USB, a memory card, a read only memory (ROM), and the like.

In addition, each of components (e.g., modules or programs) according to the diverse embodiments described above may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or the other components according to various embodiments may be executed in a sequential manner, a parallel manner, an iterative manner, or a heuristic manner, at least some of the operations may be performed in a different order or be omitted, or other operations may be added.

Although embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. An electronic apparatus comprising:
a camera;
memory storing instructions; and
at least one processor comprising processing circuitry,
wherein the instructions, when executed by the at least one processor individually or collectively, cause the electronic apparatus to:
obtain an image comprising an object, using the camera;
identify characteristic information about the object; and
generate a first sound corresponding to the object based on the characteristic information.

2. The electronic apparatus as claimed in claim 1, wherein the memory is further configured to store a first neural network model trained to output data comprising vector data representing a sound based on inputting input data, and
wherein the instructions, when executed by the at least one processor individually or collectively, further cause the electronic apparatus to:
obtain a first data comprising a first vector by inputting at least one of the characteristic information or the image to the first neural network model; and
generate the first sound based on the first data.

3. The electronic apparatus as claimed in claim 2, wherein the memory is further configured to store a plurality of second vectors acquired by encoding a plurality of sound sources, and
wherein the instructions, when executed by the at least one processor individually or collectively, further cause the electronic apparatus to:
identify a second vector having a highest similarity to the first vector among the plurality of second vectors; and
generate the first sound based on the second vector.

4. The electronic apparatus as claimed in claim 2, wherein to generate the first sound comprises to generate the first sound by decoding the first data.

5. The electronic apparatus as claimed in claim 1, wherein the memory is further configured to store a second neural network model trained to output data comprising a vector data representing a voice type based on inputting input data, and a third neural network model trained to output sound comprising a sound in voice based on inputting the data, and
wherein the instructions, when executed by the at least one processor individually or collectively, further cause the electronic apparatus to:
obtain a second data based on inputting at least one of the characteristic information or the image to the second neural network model; and
generate the first sound as a form of the sound in voice based on inputting the second data to the third neural network model.

6. The electronic apparatus as claimed in claim 1, further comprising:
at least one rack; and
a speaker,
wherein the instructions, when executed by the at least one processor individually or collectively, further cause the electronic apparatus to:
obtain the image by capturing one rack among the at least one rack by the camera based on a position of the one rack being changed; and
output the first sound through the speaker.

7. The electronic apparatus as claimed in claim 1, wherein the instructions, when executed by the at least one processor individually or collectively, further cause the electronic apparatus to:
identify the object among a plurality of objects comprised in the image, based on that a user points the object.

8. The electronic apparatus as claimed in claim 1, further comprising:
a communication interface,
wherein the instructions, when executed by the at least one processor individually or collectively, further cause the electronic apparatus to:
receive the characteristic information through the communication interface.

9. The electronic apparatus as claimed in claim 1, wherein the object is wine, and
wherein the instructions, when executed by the at least one processor individually or collectively, further cause the electronic apparatus to:
identify the characteristic information comprising at least one of: winery information, type, grape variety, grape production region, style, alcohol concentration, sweetness, acidity, tannin, or body of the wine, based on a label in the image.

10. The electronic apparatus as claimed in claim 1, further comprising:
a microphone; and
a speaker,
wherein the instructions, when executed by the at least one processor individually or collectively, further cause the electronic apparatus to:
identify the object among a plurality of objects inside the electronic apparatus based on a second sound received through the microphone; and
output the first sound corresponding to the object through the speaker.

11. The electronic apparatus as claimed in claim 10, further comprising:
at least one rack,
wherein the instructions, when executed by the at least one processor individually or collectively, further cause the electronic apparatus to change a position of a rack on which the object is placed among the at least one rack.

12. The electronic apparatus as claimed in claim 1, further comprising:
a communication interface,
wherein the instructions, when executed by the at least one processor individually or collectively, further cause the electronic apparatus to:
identify the object among a plurality of objects inside the electronic apparatus based on a second sound received from a user terminal apparatus through the communication interface.

13. A control method of an electronic apparatus, comprising:
obtaining an image comprising an object, using a camera;
identifying characteristic information about the object;
generating a first sound corresponding to the object based on the characteristic information.

14. The control method as claimed in claim 13, wherein the obtaining of the first sound comprises:
obtaining a first data comprising a first vector by inputting at least one of the characteristic information or the image to the first neural network model; and
generating the first sound based on the first data, and
wherein the first neural network model is trained to output data comprising vector data representing a sound based on inputting input data.

15. The control method as claimed in claim 14, further comprising:
identifying a second vector having a highest similarity to the first vector among a plurality of second vectors acquired by encoding a plurality of sound sources; and
generating the first sound based on the second vector.

16. The control method as claimed in claim 14, further comprising:
generating the first sound by decoding the first data.

17. The control method as claimed in claim 13, further comprising:
obtaining a second data based on inputting at least one of the characteristic information or the image to a second neural network model trained to output data comprising a vector data representing a voice type based on inputting input data; and
generating the first sound as a form of the sound in voice based on inputting the second data to a third neural network model trained to output sound comprising a sound in voice based on inputting the data.

18. The control method as claimed in claim 13, further comprising:
obtaining the image by capturing one rack among the at least one rack of the electronic apparatus, by the camera, based on a position of the one rack being changed; and
outputting the first sound through a speaker of the electronic apparatus.

19. The control method as claimed in claim 18, further comprising:
identifying the object among a plurality of objects comprised in the image, based on that a user points the object.

20. The control method as claimed in claim 13, wherein the identifying the characteristic information comprises identifying the characteristic information based on information obtained from another device.
